(19) United States
(12) Patent Application Publication
(10) Pub. No.: US 2017/0310118 A1
(43) Pub. Date: Oct. 26, 2017

(54) INDUCTIVE POSITION DETERMINATION

(71) Applicant: ZF Friedrichshafen AG, Friedrichshafen (DE)

(72) Inventors: Thomas Erdmann, Stemwede (DE); Ajoy Palit, Bremen (DE)

(73) Assignee: ZF Friedrichshafen AG, Friedrichshafen (DE)

(21) Appl. No.: 15/532,159

(22) PCT Filed: Dec. 3, 2015
(86) PCT No.: PCT/EP15/78461

§ 371 Date: Jun. 1, 2017

(30) Foreign Application Priority Data
Dec. 4, 2014 (DE) 10 2014 224 859.0

(51) Int. Cl. H02J 5/00; H04B 5/00; H01F 38/14; H04B 5/04

(52) U.S. Cl. CPC H02J 5/005; H04B 5/0043; B60L 2250/16; H01F 2038/146; H01F 2038/143; H04B 5/04; H04B 5/0031

(57) ABSTRACT

A device for the inductive positioning comprises a signal generator, a coil connected with the signal generator, an element for influencing the inductance of the coil depending on its distance to the coil and an evaluator to determine the position of the element with regard to the coil on the basis of a voltage on the coil. The signal generator thereby provides a square wave signal.

The disclosure concerns an inductive positioning. The disclosure particularly concerns the determination of a position of a device aboard a motor vehicle.

Position sensors are installed on different devices inside a motor vehicle, which scan the position of a first element with respect to a second element to thus scan the position of a concealed window, a position of a seat, or a shift position of a gear lever, for example. A position sensor for capturing such a position can be setup inductively, whereby a coil is mounted to one of the elements and a conductive element to the other. The coil may be supplied with a sine-wave voltage of a predetermined frequency, whereby it results in a complex voltage on the coil that is dependent on the inductance of the coil. The closer the conductive element is to the coil, the stronger are the eddy currents that are induced in the conductive element and that weaken the magnetic field in the area of the coil. The inductance of the coil is thus influenced negatively so that the voltage on the coil drops. The position of the elements to each other can thus be determined from the voltage resulting on the coil.

To build a sinus generator however usually requires a sensitive analogue circuit or an elaborate digital circuit. The voltage on the coil must normally also be decoupled by means of an analog measuring amplifier so that it can be evaluated. Such amplifiers can entail a pronounced temperature drift, a long settling time, and an increased susceptibility to errors.

It is therefore the task of the present disclosure to specify an improved device for the inductive positioning. The disclosure solves this task by means of a device with the features of the independent claim. Sub claims represent other embodiments.

One device for the inductive positioning comprises a signal generator, a coil connected with the signal generator, an element to influence the inductance of the coil with respect to a distance to the coil, and an evaluator to determine the position of the element in relation to the coil based on a voltage on the coil. The signal generator thereby provides a square wave signal. The signal generator provides the square wave signal for the excitation of the coil. All active electrical components that were commonly required to enable an evaluation of the voltage on the coil are thus omitted. It is no longer necessary, for example, to filter a signal of the signal generator with a low-pass filter, because a sinusoidal signal is no longer desired. The necessity to increase the signal of the signal generator is furthermore omitted, because the common energy losses caused by the filtering are thereby eliminated. The square wave signal of the signal generator can therefore supply the coil directly and/or by means of exclusively passive electrical components and the production costs of such a device can thus be reduced. It is furthermore no longer necessary to amplify the scanned coil voltage. The square wave signal can be realized by means of a digital logic circuit or by means of a programmable microcomputer. The voltage of the square wave signal can thereby correspond to common logic levels, such as 0 volt and +5 volt so that the square wave signal can be strong enough to evoke a voltage on the coil which can clearly be identified and recorded by the evaluator. An amplifier for the square wave signal can be just as dispensable as an amplifier for the voltage of the coil.

Since the number of the electrical active components is reduced in this manner, the start-up period or settling time is reduced until a stable measured value of the coil has been reached. In other words, if a rectangular pulse has been generated by the signal generator as part of the square wave signal, it takes a certain time until the voltage on the coil stabilizes. As scanning this voltage can result in a faulty scan result when the voltage is scanned before the voltage is stable, it is advantageous if this settling time is as short as possible. The settling time depends on the signal processing effort, which is operated between the signal generation and signal arrival on the coil, as well as on an ambient temperature among other things. The elimination of a low-pass filter and a signal amplifier can be described as a reduction of the signal processing effort. The settling time is therefore massively reduced by means of the inventive idea, whereby massive may signify a factor ten in this context. Since the temperature dependence of the settling time essentially depends on the temperature sensitivity of the active components such as the amplifier, for example, the settling time is shortened through a reduction of the active components also across the entire operating temperature range of the device. The operating temperature range for electronics used in automotive engineering can be between −40 degree Celsius and +110 degree Celsius, for example.

The square wave signal may comprise a number of harmonics to a basic frequency, whereby the harmonics can influence the voltage on the coil in the same manner each, so that the voltage signal on the coil can point to the position of the element with an improved accuracy. The voltage can have a reduced rise or fall time so that the position of the element can be determined more quickly. For instance, a common measurement relating to a sine-wave voltage may require a measurement time of about 300 microseconds, while the suggested device can manage with a measurement time in the range of about 10 microseconds.

The elimination of electrical components further enables a more compact design of the device. The reliability and the expected service life are hereby also increased.

In one embodiment, a resistance for the current limitation is installed downstream of the signal generator in sequence with the coil. The current that flows through the coil can thus be reduced to a specified maximum current value and the service life of the device can be increased.

In one embodiment, the coil is formed as a single-layer planar coil. By eliminating energy losses in the scanned voltage on the coil, it is no longer necessary to design the planar coil multi-layered in such a device. The production costs can therefore be reduced further, because the expenditure during the production of multi-layered coils is considerably greater than the expenditure during the production of single-layer coils. When producing multi-layered coils it is necessary, for instance, to check each coil individually. In particular, it must be ensured that there is an electrical connection between the layers of the multi-layered coil. In contrast, the entirety or functional efficiency of a single-layer coil can automatically be checked visually or optically as the entire coil is visible on a surface.

The voltage on the coil preferably comprises an alternating voltage with the frequency of the square wave signal and at least one additional alternating voltage (harmonic) with an odd multiple frequency of the square wave signal. The additional alternating voltage usually has a reduced amplitude as opposed to the first alternating voltage. The square wave signal can generally be composed of an infinite number of sine or cosine functions with frequencies, which are multiples of the basic frequency. This synthetization is also known as Fourier series. The individual signals that the square wave voltage consists of can contribute to an increased voltage which can be scanned on the signal as a measurement signal. The position of the element can thus be determined with a greater sensitivity or a greater speed. If an evaluation of the voltage is done by means of a programmable microcomputer, it can have a lower performance due to the reduced measurement period.

An alternating voltage applied to the coil is preferably integrated in a DC voltage by means of a low-pass filter. This can apply to the different alternating voltages, in particular, that the square wave signal is composed of. The single voltages can thus be joined to a total voltage easily and efficiently, whose size can point out the position of the element in an improved manner.

It is furthermore disclosed that the coil is a planar coil. The planar coil can be designed as a printed circuit on the surface of a board or another suitable carrier material, for example. In one embodiment, the planar coil is designed multi-layered, particularly two-layered. The planar coil usually only has few windings, for example in the range of about 9 to 30 windings. Accordingly, the basic inductance of the coil is relatively low. Due to the low inductance, the coil can better influence voltage components of higher frequencies so that more harmonics of the fundamental oscillation may be evaluated. The planar coil can also be easy to handle due to its low thickness especially in the field of motor vehicles.

Another embodiment provides for a controllable switching mechanism to connect one end of the coil with a predetermined potential. The coil can be connected with the predetermined potential in a simple way to perform a measurement with regard to the coil. As the switching mechanism leads to the predetermined potential, it must not be designed suitable for high frequencies so that a cost-effective low frequency transistor can be used as a switching mechanism instead of an expensive high-frequency transistor. The predetermined potential can be a ground potential in particular.

Provision may also be made for several coils with respective allocated switching mechanisms. The signal generator, the evaluator, and possibly the low-pass filter can thus be used economically several times.

Provision is also made for a control device set up to always close just one of the switching mechanisms to perform a positioning in respect to the assigned coil. The position of the element can thereby be performed successively with regard to several coils thus enabling an exact positioning also over an increased range of motion of the element.

It is furthermore disclosed that the evaluator comprises an analog-digital converter and a microcomputer, whereby the microcomputer comprises a digital output equipped to provide the square wave signal. The microcomputer can also be set up to control one or several switching mechanisms. A simple and highly integrated assembly can thus be provided which can be managed separately and which is equipped for the simple and reliable positioning of the element.

In one embodiment, the element comprises an electrically conductive attenuator. The inductance of the coil is reduced when approaching the attenuator, as eddy currents form through the magnetic alternating field in the attenuator, which reduce the energy of the magnetic alternating field.

In another embodiment, the element comprises a ferromagnetic and electrically insulating reinforcing element. The reinforcing element can, when brought close to the coil, amplify the magnetic field strength in the area of the coil and can thus increase the inductance of the coil.

In one embodiment, the device forms part of a switching mechanism for selecting a gear of a motor vehicle.

The disclosure is now described in greater detail by means of the enclosed figures, in which:

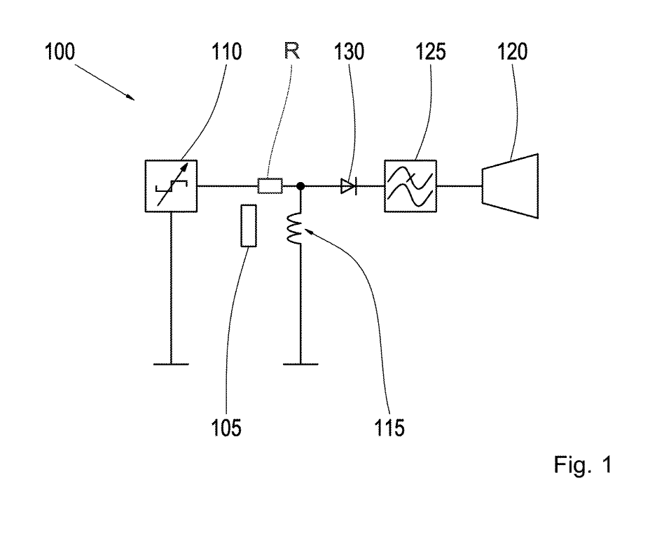

FIG. 1 shows a diagram of a device for the inductive positioning; and

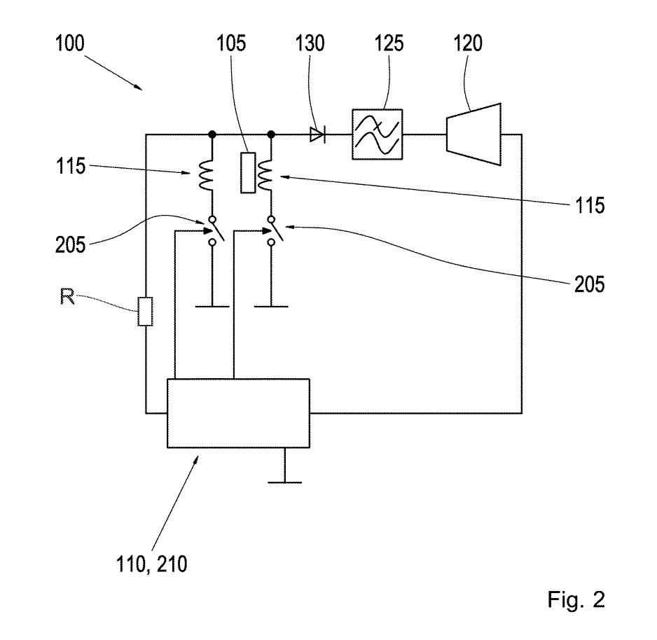

FIG. 2 shows a diagram of an expanded device according to the example of FIG. 1.

FIG. 1 shows a device 100 for the inductive determination of the positioning of an element 105. The device can be used aboard a motor vehicle, in particular, to determine a position or place of a mobile element. For example, the position of a gear lever can be scanned for a gear of a transmission in respect of a console. In another embodiment, a turning angle can be determined between the motor vehicle and a trailer coupled by means of a trailer hitch. The magnetic element 105 is generally an element which influences a magnetic alternating field that it is exposed to. The element 105 can thereby be especially electrically conductive to weaken the magnetic alternating field in the area of the coil 115, or ferromagnetically and electrically insulating to amplify the magnetic alternating field in the area of the coil 115. In one case, the element 105 can comprise copper or aluminum, for instance, in the second case, iron, nickel, or cobalt, for example. In addition to the element 105, the device 100 comprises a signal generator 110 to provide for a square wave signal, a coil 115 and an evaluator 120, and a resistor R for the current limitation, which is installed downstream with the signal generator 110 in sequence with the coil 115. The current that flows through the coil 115 can thus be limited to a preset maximum current value, and the service life of the device can be increased.

The signal generator 110 provides a square wave voltage on its output with respect to a fixed potential reference in the representation of FIG. 1 as regards to ground. The coil 115 is connected with the output of the signal generator 110 with a first end, and with another fixed potential with the other end, which can correspond to the other fixed potential. The evaluator 120 is connected with the coil 115 and is set up to scan a voltage generated on the coil 115 depending on the square wave signal of the signal generator 110. An integrator or low-pass filter 125 is therefore preferably intended between the coil 115 and the evaluator 120. A diode 130 can optionally lead in forward direction from the coil 115 to the low-pass filter 125. The low-pass filter 125 integrates high-frequency signals on the coil 115 over a predetermined period of time and provides the evaluator 120 with a respective voltage.

The position of the element 105 with regard to the coil 115 influences its inductance. Depending on the material of the element 105, the inductance of the coil 115 can be increased or reduced during the approximation of the element 105 to the coil 105. The coil 115 is preferably designed as a flat coil, whereby it has a limited extension to remain manageable. The inductance of the coil 115 is therefore relatively low. The expansion of the element 105 is usually in the area of the extension of the flat coil 115.

The square wave signal 110 can be considered a superimposition of sine or cosine signals of different frequencies and amplitudes. A first sine signal has the frequency of the square wave signal as a basic frequency. Additional sinusoidal signals have frequencies that correspond to integer multiples of the basic frequency. The higher the frequency, the lower the amplitude of the frequency in the normal case.

Odd multiples of the basic frequency have an amplifying effect towards each other, so that the coil 15, especially when its inductance is low, can react to several of the sine signals so that its voltage drop can be influenced by the position of the element 105 multiple times right away. A voltage difference on the coil 115 with a present and absent element 105 can therefore be maximized. The measurement signal can have an improved signal-to-noise ratio and an amplifier for the measurement signal can be saved.

The evaluator 120 can especially comprise a digital-to-analog converter. This can provide a numerical value on a programmable microcomputer, for example. A different signal processing of the measuring voltage is however also possible.

FIG. 2 shows a diagram of an expanded device 100 according to the example of FIG. 1. Several coils 115 are provided for, whose respective one end is connected with the signal generator 110 through the resistor R. The respective other end is connected by means of a switching mechanism 205 with the predetermined constant potential. The switching mechanisms 205 can particularly be formed through transistors. Since the switching mechanisms 205 do not have to transmit any high frequencies regardless of the frequency of the square wave signal of the signal generator 110, cost-effective low-frequency transistors can be used for this purpose, for example.

The switching mechanisms 205 are controlled by a control device 210 which can comprise a programmable microcomputer, in particular. The control device 210 is set up to close just one of the switching mechanisms 205 at any time to perform a measurement of the position of the element 105 or several elements 105 with respect to the respective assigned coil 115. The control device 210 can also perform further processing of the voltage specified by means of the evaluator 120. The evaluation can comprise numerical or statistical operations especially when the control device 210 is designed as a programmable microcomputer.

In the embodiment shown, the control device 210 is also designed to provide the square wave signal and it therefore also works as a signal generator 110. For example, a serial or parallel interface of the control device 210 can be used to provide the square wave signal with a relatively high amplitude, such as between 0 and 3.3 volt or between 0 and 5 volt. Limiters or amplifiers can be used for other voltages accordingly.

The square wave signal described above can result in short signal times of the coils 115. This means that a voltage obtainable from the coil 115 can point out the presence or absence of the element 105 faster than with a sine signal. A measuring process with a single coil 115 can thus be performed relatively quickly, such as during a measurement phase of about 10 to 20 microseconds. A measurement pause may be taken between individual measurement phases with different coils 115 each, which can be of similar duration. Due to the short measurement periods, many coils 115 can be queried by the control device 210 one after the other so that a safe and rapid positioning is also possible with a low processing capacity of the control device 210. The control device 210 in a usual application with up to about 20 coils 115 can comprise a customary 8-bit microcomputer. A 32-bit microcomputer as is necessary for measurement methods based on sine signals can be saved.

The element 105 can be designed in its dimensions with respect to the arrangement of coils 115 so that it can influence several coils 115 simultaneously. As the inductance of each coil 115 is influenced to a greater or lesser extent depending on the respective distance of the element 105, the exact position of the element 105 can then be assessed based on ratios of the voltages provided on the low-pass filters 125 influenced by the coils 115.

### REFERENCE SIGNS

100 Device
105 Element
110 Signal generator
115 Coil
120 Evaluator
125 Low-pass filter
130 Diode
205 Switching mechanism
210 Control device
R Resistor

1. A device for the inductive positioning, comprising:
a signal generator;
a coil connected with the signal generator;
an element for influencing the inductance of the coil depending on its distance to the coil;
an evaluation to determine the position of the element with regard to the coil on the basis of a voltage on the coil,
wherein the signal generator provides a square wave signal.

2. The device according to claim 1, wherein the voltage on the coil comprises an alternating voltage with the frequency of the square wave signal and at least one more alternating voltage with an integral multiple frequency of the square wave signal.

3. The device according to claim 1, wherein an alternating voltage applied to the coil is integrated in a DC voltage by a low-pass filter.

4. The device according to claim 1, wherein the coil is a planar coil.

5. The device according to claim 1, further comprising a controllable switching mechanism to connect one end of the coil with a predetermined potential.

6. The device according to claim 5, wherein several coils are included each with respectively assigned switching mechanisms.

7. The device according to claim 6, wherein a control device is included which is equipped to always just close one of the switching mechanisms to perform a positioning with respect to the coil assigned to the switching mechanism that is being closed.

8. The device according to claim 1, wherein the evaluator comprises an analog-digital converter and a microcomputer and the microcomputer comprises a digital output that is set up to provide the square wave signal.

9. The device according to claim 1, wherein the element comprises an electrically conductive attenuator.

10. The device according to claim 1, wherein the element comprises a ferromagnetic and electrically insulating amplifying element.

11. The device according to claim 1, wherein the signal generator provides the square wave signal for the excitation of the coil.

12. The device according to claim 1, wherein the square wave signal of the signal generator can supply the coil directly and by means of exclusively passive electrical components.

13. The device according to claim 1, wherein a resistor is installed downstream in series with the coil for the current limitation.

14. The device according to claim 1, wherein the coil is designed as a single-layer planar coil.

15. A switching device for selecting a gear of a motor vehicle comprising a device according to claim 1.

16. The device according to claim 1, wherein the square wave signal of the signal generator can supply the coil directly or by means of exclusively passive electrical components.

17. The device according to claim 3, further comprising a diode positioned between the coil and the low-pass filter.

18. The device according to claim 5, wherein the switching mechanism is formed through a transistor.

19. The device according to claim 6, wherein the element comprises several elements, each corresponding to one of the several coils.

20. The device according to claim 1, wherein a measurement phase of an inductive positioning measuring process carried out by the device is performed in about 10 to 20 microseconds.
